(19) United States
(12) Patent Application Publication
(10) Pub. No.: US 2021/0311861 A1
(43) Pub. Date: Oct. 7, 2021

(54) TEST AND SIMULATION OF SOFTWARE MODULES IN A DISTRIBUTED ENVIRONMENT

(71) Applicant: UP9 Inc., Palo Alto, CA (US)

(72) Inventors: Alexander HAIUT, Kfar Saba (IL); Alon GIRMONSKY, Palo Alto, CA (US); Andrey POKHILKO, Moskovskaya Obl (RU)

(21) Appl. No.: 17/217,300

(22) Filed: Mar. 30, 2021

Related U.S. Application Data
(60) Provisional application No. 63/004,034, filed on Apr. 2, 2020.

(51) Int. Cl. G06F 11/36; G06N 20/00

(52) U.S. Cl. CPC G06F 11/3688; G06F 11/3664; G06N 20/00

(57) ABSTRACT

A system which includes a processor and memory circuitry configured to obtain a training set including requests received by a software module and determine, based at least on the training set, a plurality of modelled requests, each modelled request modelling one or more requests of the training set, and linking data informative of a link between given modelled requests of the plurality of modelled requests, wherein at least one sequence of modelled requests and associated linking data are usable to test the software module, upon execution of requests for the software module in accordance with the sequence and the associated linking data.

### TECHNICAL FIELD

The presently disclosed subject matter relates to methods and systems for testing and simulating software modules in a distributed environment.

### BACKGROUND

Modern applications often rely on a distributed architecture, in which a plurality of software modules (sometimes called “micro-services”) communicate, in order to provide a service to a user (for example, email services or other websites often rely on such architecture).

Although this distributed architecture offers multiple benefits e.g. for developing and deploying the application, it is complex to ensure correct and efficient operation in such architecture.

There is now a need to provide new methods and systems for handling software modules in a distributed environment.

### GENERAL DESCRIPTION

In accordance with certain aspects of the presently disclosed subject matter, there is provided a method including, by a processor and memory circuitry (PMC), obtaining a training set including requests received by a software module, determining, based at least on the training set, a plurality of modelled requests, each modelled request modelling one or more requests of the training set, and linking data informative of a link between given modelled requests of the plurality of modelled requests, wherein at least one sequence of modelled requests and associated linking data are usable to test the software module, upon execution of requests for the software module in accordance with the sequence and the associated linking data.

In addition to the above features, the method according to this aspect of the presently disclosed subject matter can optionally comprise one or more of features (i) to (x) below, in any technically possible combination or permutation:
i. the linking data includes data informative of a link between a value of a variable parameter of at least one modelled request and a response associated with at least one of another modelled request,
ii. determination of a modelled request includes determining, for each request of a plurality of requests of the training set, a variable part of the request,
iii. the method includes determining, for each request of a plurality of requests of the training set: a constant part of the request, a variable part of the request corresponding to a variable parameter, generating a modelled request modelling requests sharing a same constant part, and a variable part corresponding to a same variable parameter;
iv. the method includes, for a plurality of given requests of the training set, obtaining responses of the software module associated with the given requests, based on the responses and a variable part determined for each given request, determining data informative of a link between a value of a variable part of a modelled request modelling a given request and a response associated with a modelled request modelling another given request;
v. the method includes determining a plurality of candidates for the linking data, based at least on requests of the training set, responses associated with the request, and a variable part identified for the requests of the training set and using a machine learning algorithm to determine the linking data among the plurality of candidates;
vi. the method includes generating, based on at least one sequence of modelled requests and associated linking data, a test usable to test the software module, upon execution of requests in accordance with the sequence and associated linking data;
vii. the method includes obtaining an ordered sequence of modelled requests, and associated linking data, generating a request corresponding to a first modelled request of the sequence; for each of all other modelled requests of the sequence, generating a request which includes a constant part extracted from the modelled request, and a variable part, whose value is determined based on the linking data;
viii. the method includes at least one of (i) dividing the requests of the training set into a plurality of distinct user interactions and (ii) deleting redundant requests;
ix. the method includes testing the software module using the test; and
x. the method includes storing, for each modelled request, one or more responses of the training set, wherein the modelled requests and the one or more responses are usable to simulate a response of the software module, upon execution of a request for the software module.

According to some embodiments, there is provided a non-transitory storage device readable by a machine, tangibly embodying a program of instructions executable by the machine to perform operations as described above.

According to another aspect of the presently disclosed subject matter there is provided a method including, by a processor and memory circuitry (PMC): obtaining, for a software module, a plurality of modelled requests, each modelled request modelling one or more requests received by the software module, and linking data informative of a link between given modelled requests of the plurality of modelled requests, generating, based on at least one sequence of modelled requests and associated linking data, a test usable to test the software module, upon execution of requests for the software module in accordance with the selected sequence and associated linking data.

According to some embodiments, upon testing response of the software module to a given request, the method includes generating a test including a number of requests allowing covering the given request which is minimal according to a criterion, based on the plurality of modelled requests and the linking data.

According to some embodiments, the method includes storing, for each modelled request modelling one or more requests, one or more responses of the software module to the one or more requests, wherein the modelled requests and the one or more responses are usable to simulate a response of the software module, upon execution of a request for the software module.

According to some embodiments, there is provided a non-transitory storage device readable by a machine, tangibly embodying a program of instructions executable by the machine to perform operations as described above.

According to another aspect of the presently disclosed subject matter there is provided a method including, by a processor and memory circuitry (PMC): obtaining a training set including a plurality of pairs of requests and responses of a software module, determining a plurality of modelled requests modelling the requests of the training set, wherein one or more given requests of the training set are modelled by a modelled request including a variable part identified for the one or more given requests, wherein one or more of the modelled requests and the responses of the training set are usable to simulate a response of the software module, upon receipt of a request.

According to some embodiments, the method includes simulating a response of the software module to a given request, the simulating including, upon receipt of the given request, searching for a modelled request modelling the given request, and outputting a response associated with the modelled request and matching the given request.

According to some embodiments, there is provided a non-transitory storage device readable by a machine, tangibly embodying a program of instructions executable by the machine to perform operations as described above.

According to another aspect of the presently disclosed subject matter there is provided a method including, by a processor and memory circuitry (PMC), obtaining a data structure storing a plurality of modelled requests modelling requests to a software module, and one or more responses of the software module associated with each modelled request, obtaining a given request for the software module, and generating a response simulating behaviour of the software module in response to the given request, the generating, including searching in the data structure for a given modelled request modelling the given request, outputting a response which is associated with the given modelled request in the database and which matches the given request.

According to some embodiments, there is provided a non-transitory storage device readable by a machine, tangibly embodying a program of instructions executable by the machine to perform operations as described above.

According to another aspect of the presently disclosed subject matter there is provided a system including a processor and memory circuitry (PMC)configured to obtain a training set including requests received by a software module, determine, based at least on the training set, a plurality of modelled requests, each modelled request modelling one or more requests of the training set, linking data informative of a link between given modelled requests of the plurality of modelled requests, wherein at least one sequence of modelled requests and associated linking data are usable to test the software module, upon execution of requests for the software module in accordance with the sequence and the associated linking data.

In addition to the above features, the method according to this aspect of the presently disclosed subject matter can optionally comprise one or more of features (xi) to (xix) below, in any technically possible combination or permutation:
xi. the linking data includes data informative of a link between a value of a variable parameter of at least one modelled request and a response associated with at least one of another modelled request;
xii. upon determination of a modelled request, the system is configured to determine, for each request of a plurality of requests of the training set, a variable part of the request;
xiii. the system is configured to determine, for each request of a plurality of requests of the training set, a constant part of the request, a variable part of the request corresponding to a variable parameter, and generate a modelled request, modelling requests sharing a same constant part, and a variable part corresponding to a same variable parameter;
xiv. the system is configured to, for a plurality of given requests of the training set, obtain responses of the software module associated with the given requests, based on the responses and a variable part determined for each given request, determine data informative of a link between a value of a variable part of a modelled request modelling a given request and a response associated with a modelled request modelling another given request;
xv. the system is configured to determine a plurality of candidates for the linking data, based at least on requests of the training set, responses associated with the request, and a variable part identified for the requests of the training set; and use a machine learning algorithm to determine the linking data among the plurality of candidates;
xvi. the system is configured to generate, based on at least one sequence of modelled requests and associated linking data, a test usable to test the software module, upon execution of requests in accordance with the sequence and associated linking data;
xvii. the system is configured to obtain an ordered sequence of modelled requests, and associated linking data, generate a request corresponding to a first modelled request of the sequence, for each of all other modelled requests of the sequence, generate a request which includes a constant part extracted from the modelled request, and a variable part whose value is determined based on the linking data;
xviii. the system is configured to test the software module using the test; and
xix. the system is configured to store, for each modelled request, one or more responses of the training set, wherein the modelled requests and the one or more responses are usable to simulate a response of the software module, upon execution of a request for the software module.

According to another aspect of the presently disclosed subject matter there is provided a system including a processor and memory circuitry (PMC)configured to obtain a training set including a plurality of pairs of requests and responses of a software module, and determine a plurality of modelled requests modelling the requests of the training set, wherein one or more given requests of the training set are modelled by a modelled request including a variable part identified for the one or more given requests, wherein one or more of the modelled requests and the responses of the training set are usable to simulate a response of the software module, upon receipt of a request.

According to some embodiments, the system is configured to, upon simulation of a response of the software module to a given request, upon receipt of the given request, search for a modelled request modelling the given request, and output a response associated with the modelled request and matching the given request.

According to another aspect of the presently disclosed subject matter there is provided a system including a processor and memory circuitry (PMC)configured to obtain a data structure storing a plurality of modelled requests modelling requests to a software module, and one or more responses of the software module associated with each modelled request, obtain a given request for the software module, and generate a response simulating behaviour of the software module in response to the given request, the generating including search in the data structure for a given modelled request modelling the given request, output a response which is associated with the given modelled request in the database and which matches the given request.

According to some embodiments, the proposed solution is able to automatically generate a test of a software module, which reflects real interaction of the software module with one or more third parties (e.g. a user and/or other software modules). Automatic generation of the test reduces, in particular, time, cost and human resources required to conceive and implement a test software.

According to some embodiments, the proposed solution improves testing of software modules in a distributed environment. In particular, the test better reflects actual scenarios encountered by the software module, by providing accurate and relevant test(s).

According to some embodiments, the proposed solution is able to automatically model real interactions of a software module with one or more third parties (e.g. a user and/or other software modules).

According to some embodiments, the proposed solution is able to automatically generate a test of a software module which covers specific requests which can be exchanged by the software module.

According to some embodiments, the proposed solution eases development of applications relying on a multiplicity of interrelated software modules. In addition, it improves quality of tests of these applications, and, in turn, operability and efficiency of the final applications.

According to some embodiments, the proposed solution eases testing of interrelated software modules in a distributed environment in which each software module can encounter various releases and changes over time, thereby inducing complexity in testing each software module (in some cases, each software module can even be developed by different engineering teams over the world).

According to some embodiments, the proposed solution is operative to simulate real operation of one or more software modules implemented in a distributed environment.

According to some embodiments, simulated operation of a given software module implemented in a distributed environment provides various benefits, such as improving testing of one or more other software modules of the distributed environment communicating with the given software module, providing demonstration of the operation of the given software module, improving development of the given software module, etc.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an embodiment of an architecture of a distributed architecture including a plurality of software modules;

FIG. 2 illustrates an embodiment of a method of determining modelled requests and linking data representative of data communication of a software module;

FIG. 3 illustrates an embodiment of a method of pre-processing a training set informative of data communication of a software module;

FIG. 4 illustrates an embodiment of another method of pre-processing a training set informative of data communication of a software module;

FIG. 4A illustrates a non-limitative example of the method of FIG. 4;

FIG. 5 illustrates an embodiment of a method of determining modelled requests;

FIGS. 5A to 5D illustrate non-limitative examples of the method of FIG. 5;

FIG. 6 illustrates an embodiment of a method of determining linking data between modelled requests;

FIG. 6A illustrates an embodiment of the method of FIG. 6;

FIG. 6B illustrates a non-limitative example of a data structure which can be obtained based on the methods of FIGS. 2, 6 and 6A;

FIGS. 6C and 6D illustrate a non-limitative example of the method of FIGS. 6 and 6A;

FIG. 7 illustrates an embodiment of a method of generating a test of a software module;

FIG. 7A illustrates an embodiment of a method of generating a test of a software module which meets one or more constraints;

FIG. 8A illustrates an embodiment of a distributed architecture including a plurality of software modules, and FIG. 8B illustrates the same architecture in which a software module is replaced by a simulated software module;

FIG. 9 illustrates an embodiment of a method of building a data structure usable to simulate a software module;

FIG. 10 illustrates a non-limitative example of the method of FIG. 9;

FIG. 11 illustrates an embodiment of a method of simulating a software module; and

FIG. 12 illustrates a non-limitative application of the method of FIG. 11.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification discussions utilizing terms such as “obtaining”, “determining”, “generating”, “dividing”, “deleting”, “testing”, “using” or the like, refer to the action(s) and/or process(es) of a processor and memory circuitry (PMC) that manipulates and/or transforms data into other data, said data represented as physical, such as electronic, quantities and/or said data representing the physical objects.

The term “processor and memory circuitry” covers any computing unit or electronic unit with data processing circuitry that may perform tasks based on instructions stored in a memory, such as a computer, a server, a chip, a processor, a hardware processor, etc. It encompasses a single processor or multiple processors, which may be located in the same geographical zone or may, at least partially, be located in different zones and may be able to communicate together.

The term “memory” as used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

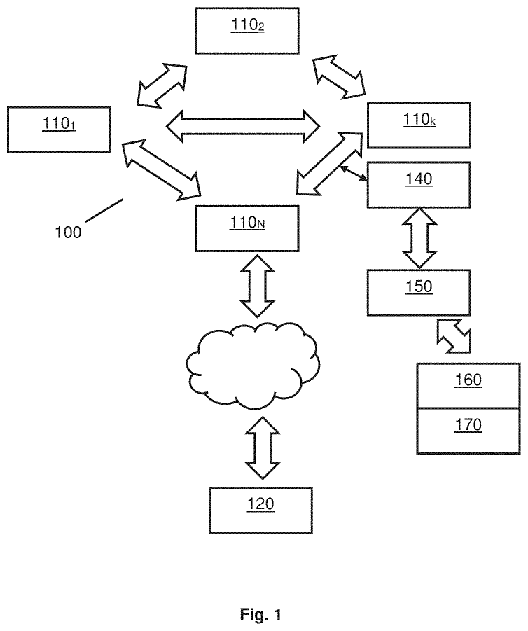

FIG. 1 illustrates a non-limitative example of a distributed architecture including a plurality of software modules 110₁, . . . 110_{N}. The group of software modules 110₁, . . . 110_{N} can be part e.g. of an application 100, wherein each software module implements a different service of the application 100.

According to some embodiments, a software module includes a list of instructions stored in a non-transitory memory, the instructions being such that, when executed by a processor and memory circuitry (PMC), cause the processor and memory circuitry (PMC) to perform one or more operations in accordance with the instructions.

The software module can be implemented e.g. on a host which can include at least one server (which includes processing capabilities, and storage capabilities, such as a memory) and/or on at least one virtual machine (a virtual machine generally includes computer files that run on a physical computer or server, and behaves like a physical server or computer).

Each software module 110ᵢ can exchange data with a third party, which includes e.g. one or more other software modules (110ⱼ, with j different from i) and/or a computing device 120 (e.g. computer, smartphone) of a user. Exchanged data can include e.g. various requests, which can be encoded using an adapted protocol.

According to some embodiments, a software module 110ᵢ (with 1≤i≤n) can interact with a third party (such as a computing device of a user and/or another software module) using an application programming interface (API). In some embodiments, the API is a Web-based API, such as RESTFul Web API. This is, however, not limitative. When an API is used, data communication between the different software modules can include API calls (also called API requests).

A non-limitative example of an application 100 is an email service. A first software module can handle authentication of user, another software module can handle display of emails, another software module can handle online chat, etc. The first software module is generally designated as a front-end service since it has direct interaction with the user. Inter-communication between the different software modules allows the email service to operate for a user.

According to some embodiments, a data communication module 140 is implemented. The data communication module 140 is configured to listen to data communication of a given software module. In particular, the data communication module 140 is configured to collect at least one of:
data received by the given software module, and
data transmitted by the given software module.

For example, a set of routing rules of a host on which the given software module is implemented defines how to route inbound and/or outbound data traffic of the software module. In a Linux-based host, the set of routing rules is called “IPTables Rules”. It is therefore possible to manipulate the set of routing rules such that data communication of the given software module is redirected to the data communication module 140. The data communication module 140 can forward the collected data in parallel e.g. to a database 150 (or to another third party of interest) and to the original destination of the data (the data communication module 140 acts therefore as a proxy).

In some embodiments, the data communication module 140 can be implemented as a side car container.

In some embodiments, collection of data exchanged by a given software module with a third party can rely on other solutions, such as network sniffing techniques and modules (which rely e.g. on passive components), application monitoring and logging solutions, etc.

A processor and memory circuitry (PMC)(see processing unit 160 and associated memory 170) can be used to process a training set built based on data communication of at least one software module and/or to perform one or more of the methods described hereinafter.

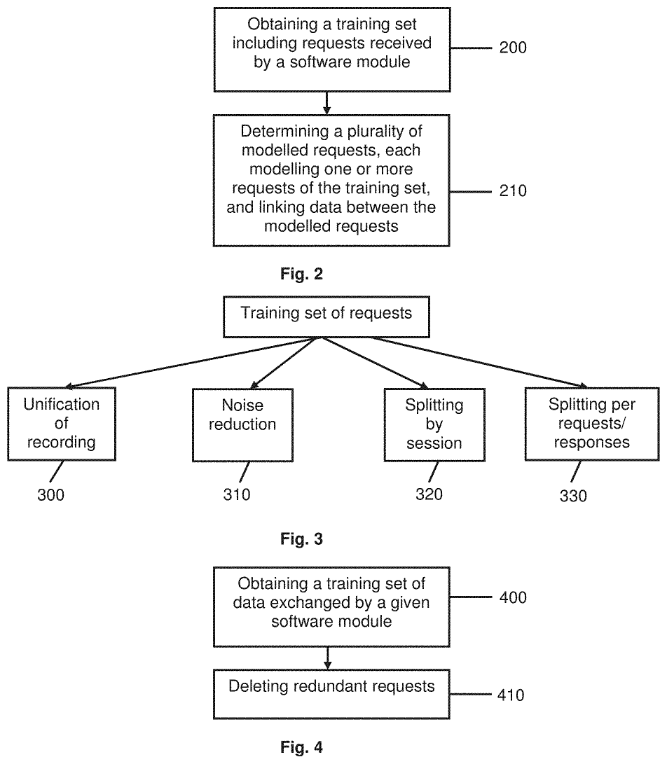

Attention is now drawn to FIG. 2.

Assume that it is intended to generate a test for a given software module (e.g. software module 110ₖ with k between 1 and N) which, as mentioned in FIG. 1, can be part of a distributed architecture.

A method can include obtaining (operation 200) a training set collected based on data communication of the given software module 110ₖ with at least one third party (which can include e.g. other software modules, and/or a computing device of a user).

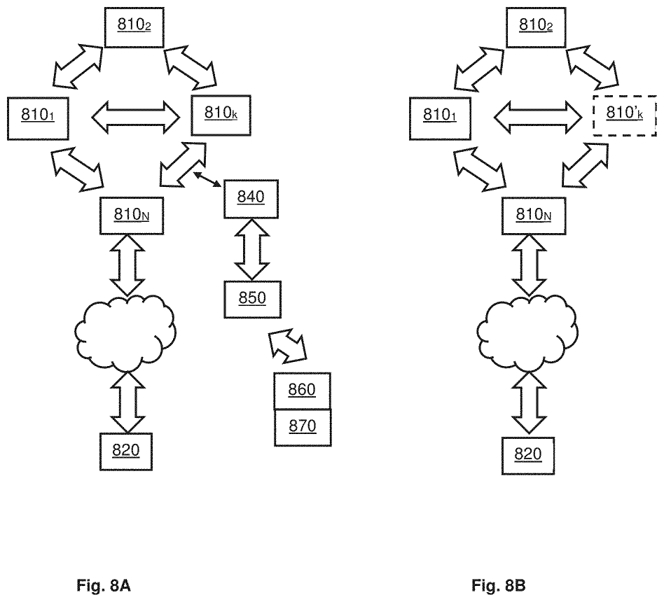

The training set can in particular include requests received by the given software module 110ₖ during its operation. In some embodiments, the training set of requests can be collected during communication of the given software module with real other software modules. In other embodiments, as explained hereinafter (see e.g. FIGS. 8 to 12), at least one of the other software modules can be simulated.

In a non-limitative example, a Web API handles data communication of the given software module 110ₖ, and the training set of requests can include a list of URLs.

Operation 200 can include collecting the training set using e.g. a data communication module 140, which acts as a proxy with respect to the given software module 110ₖ.

In some embodiments, operation 200 can include obtaining the training set from a database in which the training set of requests is already available.

According to some embodiments, the training set can include, for each request, a response associated with the request (indeed, at least some requests to a software module require the software module to provide data as a response). The responses can be collected using e.g. the data communication module 140.

The method can further include determining (operation 210), based at least on the training set:
a plurality of modelled requests, each modelled request modelling one or more “real” requests of the training set received by the software module, and
linking data informative of a link between given modelled requests of the plurality of modelled requests.

As explained hereinafter, the modelled requests and the linking data allow modelling various possible real scenarios that occur during operation of the given software module. Embodiments of processing tasks which can be part of operation 210 are described hereinafter.

As explained hereinafter, at least one sequence of modelled requests and associated linking data are usable to test the software module. In particular, the selected sequence and the associated linking data can be used to generate a test which includes execution of requests for the software module in accordance with the selected sequence and the associated linking data, thereby reproducing an ordered sequence of “real” requests received by the software module. Various examples are provided hereinafter.

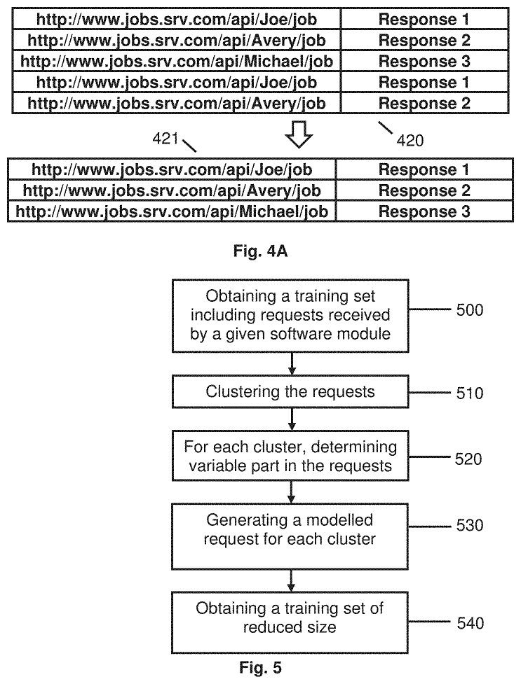

Attention is now drawn to FIG. 3.

According to some embodiments, the training set which has been collected from data communication of the given software module 110ₖ can be pre-processed.

According to some embodiments, pre-processing can include unification of recording (operation 300). This stage can include translating the training set, which, in some embodiments, can be gathered or received through a variety of methods (e.g. proxy, sniffing techniques, etc.), into a unified format that can be processed in subsequent stages. An example of unified format is the JSON format (this is not limitative).

According to some embodiments, pre-processing can include reducing noise present in the training set (operation 310). This includes processing the training set to keep data related to the software module (such as HTTP protocol headers, relevant to further analysis) and discarding other data, such as rich media content (images, videos, formatting data) or other non-API related data.

According to some embodiments, pre-processing can include splitting the training set into a plurality of different sessions (operation 320).

Since data communication is collected on the side of the software module (which corresponds to the “server” side), requests transmitted by different users can be collected in the same recording of the data communication module 140. These requests, which are associated to different users, are generally interlaced over time.

Operation 320 can include splitting the training set into a plurality of groups (also called “sessions” or “user sessions”), wherein each group corresponds to an interaction of a different user with the given software module 110ₖ. For example, the first group corresponds to all requests transmitted by user 1 to the software module (with their associated responses), the second group corresponds to all requests transmitted by user 2 to the software module (with their associated responses), etc. Separation of the requests into groups can be performed using identification data associated with the requests (e.g. IP address, identification data associated with the browser sending the request, etc.).

According to some embodiments, the given software module 110ₖ can interact with other software modules (as depicted in FIG. 1). Operation 320 can include splitting the requests (exchanged with other software modules) into a plurality of groups, wherein each group corresponds to an interaction of a different software module (110ⱼ with j different from k, and 1≤j≤N) with the given software module 110ₖ. For example, the first group corresponds to all requests received by the given software module 110ₖ from software module 110₁ (with their associated responses), the second group corresponds to all requests received by the given software module 110ₖ from software module 110₂ (with associated responses), etc.

According to some embodiments, pre-processing can include splitting (operation 330) the training set into a plurality of pairs of data, each pair including a request and a corresponding response. For example, a pair can include a request “http://ppl.srv.com/api/who?id=1” to the software module and a corresponding response “{id:1, name=Joe}”.

When a request is not associated with a response, then the second field of the pair can be empty.

According to some embodiments, splitting the training set into a plurality of pairs of data is performed separately for each group obtained at operation 320.

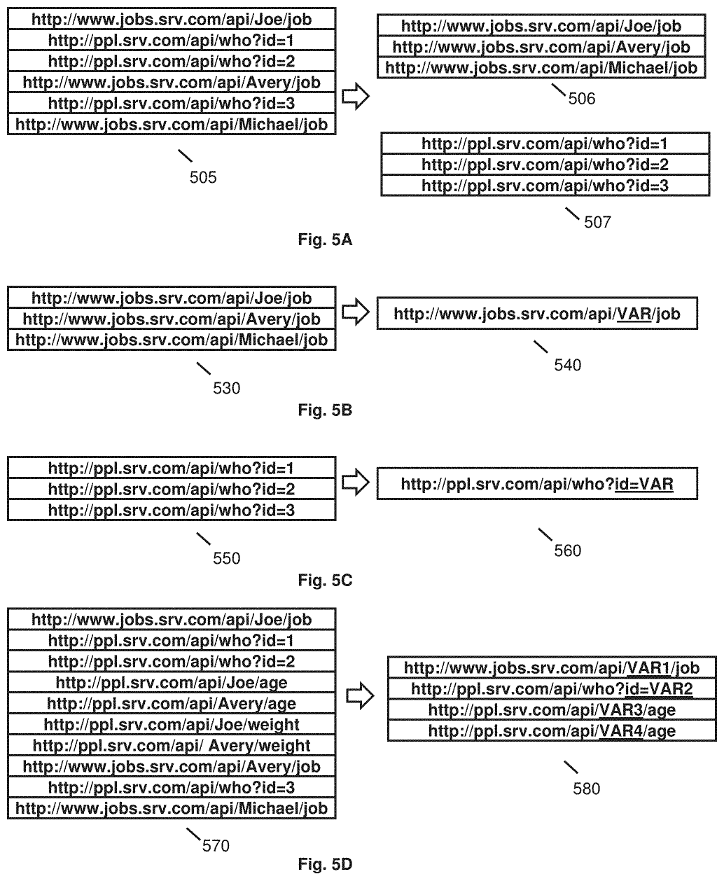

Attention is now drawn to FIG. 4.

The training set can be processed to delete redundant requests (operation 410), together with the associated responses. According to some embodiments, operation 410 is applied on the training set which has been obtained after splitting the requests into distinct groups (operation 320).

A non-limitative example is illustrated in FIG. 4A, in which the training set 420, including requests and their associated responses, is reduced into the training set 421. As a consequence, only unique requests (with their associated responses) are kept, thereby facilitating further processing.

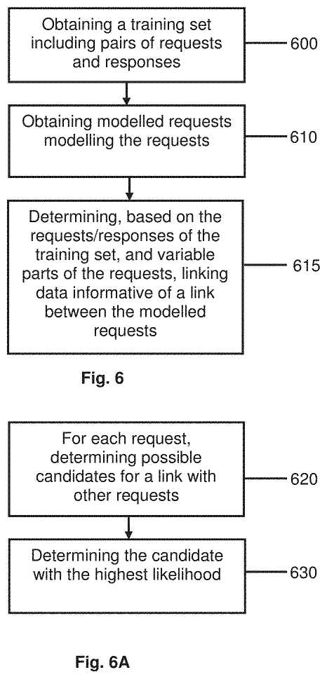

Attention is now drawn to FIG. 5.

A method can include, for each request of a plurality of requests of the training set obtained at operation 500, determining a variable part of the request. According to some embodiments, the training set obtained at operation 500 corresponds to a training set after pre-processing tasks such as operation 320 and the method of FIG. 4.

For example, in the requests illustrated in the training set 420 of FIG. 4A:
in the first request, the variable part has value “Joe”;
in the second request, the variable part has value “Avery”;
in the third request, the variable part has value “Michael”.

The other parts of the requests correspond to a constant part for all of these requests (since it is identical for these group of requests).

In order to identify a variable part in a plurality of requests, in some embodiments the method can include clustering (operation 510) the different requests into a plurality of clusters, wherein requests belonging to the same cluster are similar according to a similarity criterion. For example, if the requests include URLs, then URLs for which most of the URL address (e.g. the host of the URL) is identical, will be assigned to the same cluster. Clustering can be performed using e.g. an algorithm such as K-means, or K-modes. A non-limitative example is illustrated in FIG. 5A. Assume that the training set includes the requests 505, then the training set can be divided into two clusters 506 and 507.

For each cluster, it is attempted to determine a variable part (operation 520) which is common to the requests of the cluster (that is to say that the variable part corresponds to a same variable parameter which can have a different value, depending on the request). Identification of the variable part can include feeding the list of requests (of a given cluster) to a machine learning algorithm (e.g. deep neural network, convolutional neural network, or similar networks) which outputs an estimation of the variable part. The output of the machine learning algorithm can also include the constant part of the requests of the cluster.

Based on this estimation, it is possible to generate (operation 530) a modelled request, which models one or more requests of the cluster. In particular, the modelled request models requests sharing a same constant part, and a variable part corresponding to a same variable parameter (although the specific value of the variable parameter can differ for these requests).

Following the process of FIG. 5, a new training set of reduced size is obtained (operation 540). In this new training set, requests which share a same constant part and a variable part corresponding to a same variable parameter are replaced by a modelled request. In order to facilitate reference to this new training set, it is called hereinafter “modelled training set”.

A non-limitative example is provided in FIG. 5B.

A cluster 530 includes three requests, and the machine learning algorithm has identified that the values “Joe”, “Avery” and “Michael” in the requests correspond to a variable part. As a consequence, a modelled request 540 can be generated, which includes a constant part common to all requests, and for which the specific values of the variable parameter are replaced by a variable “VAR” which indicates location of the variable part in the request.

Another example is illustrated in FIG. 5C, in which requests of cluster 550 are processed to identify a variable part, and a modelled request 560 is generated.

According to some embodiments, the variable part of the requests can include a plurality of different parameters (and not necessarily a single parameter).

FIG. 5D illustrates reduction of the size of the initial training set, from the training set 570 (which can be obtained in some embodiments after one or more pre-processing tasks of FIGS. 3 and 4) to the modelled training set 580, which includes modelled requests, each modelling one or more true requests of the initial training set.

Although a smaller training set modelling the initial training set is generated, the initial training set (e.g. obtained after pre-processing tasks described above) is kept for further processing, as explained hereinafter.

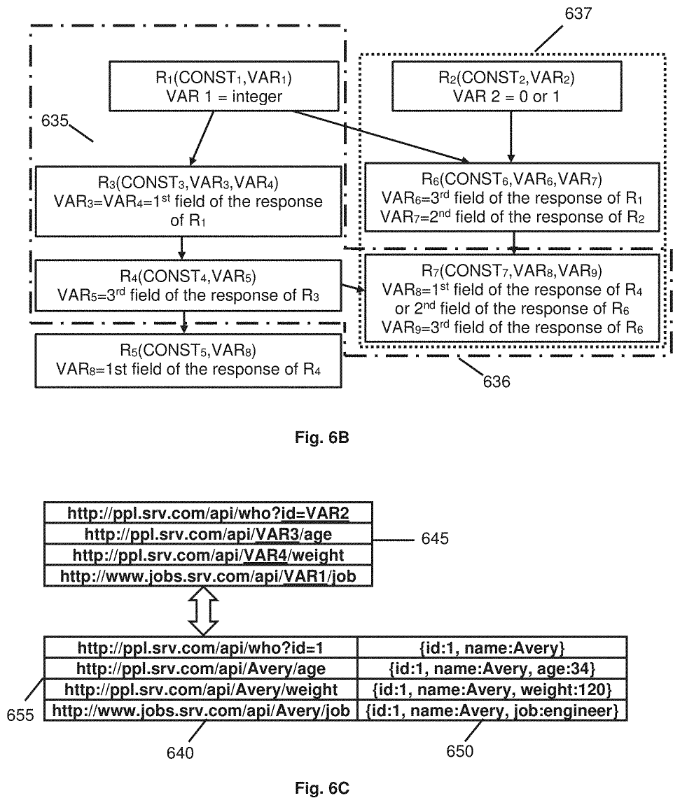

Attention is now drawn to FIG. 6.

Assume that a plurality of requests of a training set (obtained at operation 600) has been used to generate a modelled training set (see operation 610) using e.g. the method of FIG. 5 (see a non-limitative example in FIG. 5D). As explained above, each modelled request of the modelled training set models one or more true requests of the training set.

It can be attempted to determine linking data informative of a link between given modelled requests of the modelled training set. This linking data can include (this data allows generating one or more ordered sequences of requests, as explained hereinafter):
data indicative that a given modelled request depends on one or more other (previous) modelled requests of the modelled training set, and
data informative of a link between a value of a variable part of a modelled request, and one or more other modelled requests (in particular of responses obtained for these other modelled requests).

The method can include determining (operation 615), based on pairs of requests/responses of the training set and on data indicative of variable part of the requests of the training set (this data is present in the modelled training set), linking data informative of a link between the modelled requests of the modelled training set.

For each given modelled request of the modelled training set, it can be therefore determined whether it depends from one or more other modelled requests of the modelled training set, and which input of the given modelled request is required from a response of these one or more other modelled requests.

The modelled requests, together with the linking data, can be stored in a data structure (for example a graph, this is not limitative) which is therefore usable to generate one or more sequences of ordered requests (each sequence modelling a sequence of true requests of the training set).

FIG. 6A illustrates a possible implementation of operation 615.

A training set includes a plurality of pairs, each pair including a request received by a software module and a corresponding response, which have been collected over time (collection of the training set preserves the time order of the requests). For each request, it is known which part corresponds to a variable part (as explained with reference to FIG. 5). The method can include determining (operation 620), for each request of the training set (which is not the first request of the training set), whether value of the variable part of the request matches (according to a matching criterion) value of a response of a past request of the training set.

For each variable part of each request, one or more candidates can be obtained. In other words, for each request, one or more possible links (“candidates”) with other requests of the training set are identified.

The method can further include selecting (630) the candidate with the highest likelihood. This operation can include feeding the candidates to a machine learning algorithm trained to identify the link with the highest likelihood.

The machine learning algorithm can include e.g. a Deep Neural Network, a Convolutional Neural Network, Gradient Boosting, etc.

The machine learning algorithm can be trained using supervised learning. A plurality of training sets are fed to the machine learning algorithm, together with a label (e.g. provided by an operator) which indicates the correct link between the requests for each training set. Based on a difference between prediction of the machine learning algorithm and the label, coefficients of the machine learning algorithm can be updated (using e.g. backpropagation, or other adapted techniques). In some embodiments, the machine learning algorithm can be trained to select the link with links to the current request and a previous request which is the earliest over time among all possible candidates.

Once the best link has been identified for specific requests of the training set, linking data can be stored which models this link, and includes, for each variable part of a given modelled request, dependency with respect to e.g. a response to another modelled request of the modelled training set. Some requests can be such that they do not depend from another request of the training set, because they correspond to an initial request of a sequence.

If the initial training set has been split into a plurality of groups (see operation 320
each group corresponding to a different user of software interaction) then linking data is obtained for the modelled requests of each group. In some embodiments, all modelled requests and all linking data of all groups can be stored in a common data structure.

Attention is now drawn to FIGS. 6B and 6C.

A non-limitative example of a data structure which can be obtained using the methods of FIGS. 6 and 6A is illustrated in FIG. 6B (see data structure 635).

As shown, modelled request R₃ includes a constant part “CONST₃” and variable parameters “VAR₃” and “VAR₄”. The data structure 635 indicates that modelled request R₃ depends on modelled request R₁. In particular, the data structure 635 indicates that the value of variable VAR₃ corresponds to the first field of the response of modelled request R₁ (linking data).

As shown, the data structure 635 stores a plurality of modelled requests, and for each request, it indicates whether it depends on other modelled requests, and the linking data between the modelled requests.

Modelled request R; includes a constant part “CONST₇” and variable parameters “VAR₈” and “VAR₉”. The data structure 635 indicates that modelled request R₇ depends both on modelled requests R₄ and R₆. In addition, the data structure 635 indicates that the value of variable VAR₈ corresponds to the first field of the response of modelled request R₄ or to the second field of the response of modelled request R₆ and that the value of variable VAR) corresponds to the third field of the response of modelled request R₆ (linking data).

For all variable parameters of the data structure 635 which do not depend on responses of previous modelled requests (for example, in FIG. 6A, parameters “VAR₁”, “VAR₂”) the data structure 635 can store possible values of these parameters, based on the training set of requests and responses collected for the software module. For example, from the responses collected in the training set, it is known that VAR₁ is an integer (using e.g. text recognition algorithms) and that VAR₀ is either equal to 0 or 1.

FIG. 6C illustrates a non-limitative example of the method of FIGS. 6 and 6A. Assume that a training set 655 has been collected for a given software module, which includes pairs of requests 640 and responses 650.

The requests 640 can be modelled by the modelled requests 645, in which the constant and variable parts have been identified.

By applying the method of FIGS. 6 and 6A, it can be identified that the variable part of the request http://ppl.srv.com/api/Avery/age (“Avery” is a specific value of variable part VAR₃) depends from the response “name” to the first request http://ppl.srv.com/api/who?id=1 (which is modelled by http://ppl.srv.com/api/who?id=VAR2). This linking data is stored in a data structure 670 (see FIG. 6D).

Similarly, it can be identified that the variable part of the request http://ppl.srv.com/api/Avery/weight (“Avery” is a specific value of variable part VAR₄) depends from the response “name” to the first request http://ppl.srv.com/api/who?id=1 (which is modelled by http://ppl.srv.com/api/who?id=VAR2). This linking data is stored in the data structure 670 (see FIG. 6D).

Similarly, it can be identified that the variable part of the request http://www.jobs.srv.com/api/Avery/job (“Avery” is a specific value of variable part VAR₁) that depends from the response “name” to the first request http://ppl.srv.com/api/who?id=1 (which is modelled by http://ppl.srv.com/api/who?id=VAR2). This linking data is stored in the data structure 670 (see FIG. 6D).

Concerning the variable part “VAR2” of the first request http://ppl.srv.com/api/who?id=1, it is not derived from other requests in the training set 655. Therefore, possible value(s) of “VAR2” can be stored in the data structure 670 (see FIG. 6D).

Although in the simplistic example of FIG. 6D, there is only one possible candidate for the link between the requests, this is not limitative, and in practice, many candidates can be identified, among which the most likely candidate can be selected (as explained in FIG. 6A).

Although the data structure 670 is schematically illustrated in FIG. 6D as a table, this is not limitative and any adapted representation can be used.

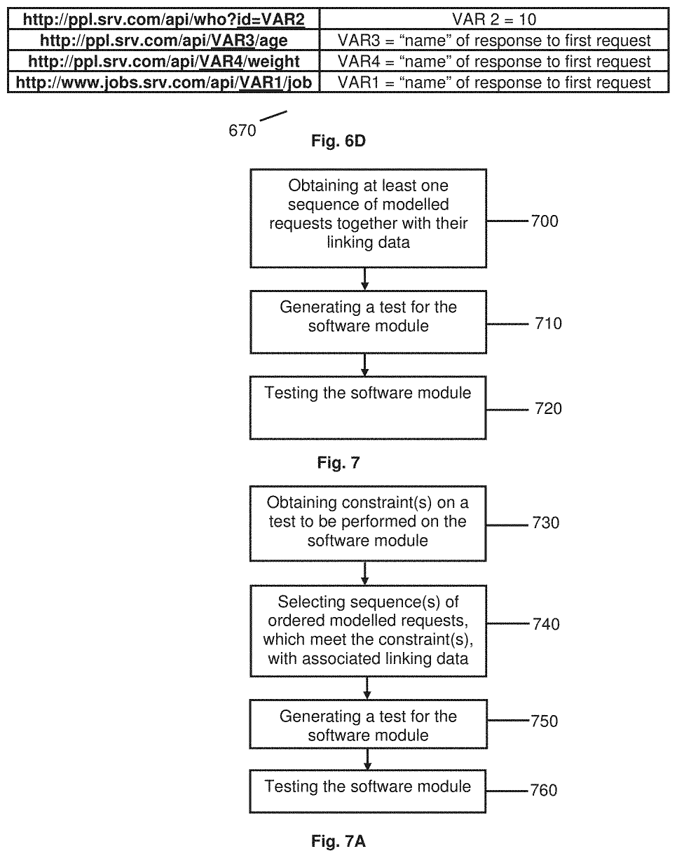

Attention is now drawn to FIG. 7.

A possible use case of the data structure (see e.g. 635) obtained for a software module is the generation of a test for the software module.

The method can include obtaining at least one sequence of modelled requests together with their linking data (operation 700).

In particular, the data structure allows selecting an ordered sequence of modelled requests (which reflect a true sequence of requests).

As explained above, the modelled requests are represented as including a constant part and a variable part. For the first modelled request of the selected sequence, possible value(s) of the variable part of the first request can be obtained from the data structure and for the other modelled requests, linking data between the variable part of the modelled request and responses to previous modelled requests of the sequence can be obtained. This data allows building a sequence of requests to be sent to the software module, simulating a real scenario (test) which can be encountered by the software module under operation.

The method can include generating (operation 710), based on the sequence, a test for the software module. In particular, upon execution of the test, requests are sent to the software module which comply with the selected sequence (which in turn is representative of real operation of the software module), thereby simulating a real scenario which can be encountered by the software module. Generation of the test can include converting the selected sequence into a programming language reflecting the sequence. The test can be generated in a given programming language (for example Python, Javascript, this being not limitative).

For a given sequence of modelled requests used to generate a test, the first request of the test can be generated based on the first modelled request of the sequence, and on possible values of its variable part. The first request can be seen as a “seed” of the given sequence, for which it is necessary to obtain possible real values of its variable part.

The other subsequent requests of the test can be generated as follows: the constant part of the request is extracted from the constant part of the corresponding modelled request, and the value of the variable part of the request is determined based on the linking data. Therefore, once the first request is executed, the other subsequent requests can be executed since their constant part is known from the modelled request and their variable part depends on response(s) of the software module to previous requests. It is therefore not necessary to obtain real values of the variable parts of the subsequent requests, since they are automatically generated following execution of the first request (provided the software module is successful in responding to the requests of the test).

According to some embodiments, the test can further include, for each request and/or sequence of requests used to test the software module, a criterion (or criteria), defining whether the test corresponds to a success or to failure.

The criterion depends on the type of protocol, the software module, the nature of the API, and other parameters. Non-limitative examples of criteria are provided below (other criteria can be used):
HTTP status code (200/30× correspond to a success and 40×/50× correspond to a failure);
Content of the HTML based response (e.g. HTML page title, header—if the response is empty, this can correspond to a failure);
JSON format is valid (the response is not empty, the content type and size are correct, the value of the response is correct, etc.).

According to some embodiments, the method can further include testing (operation 720) the software module using the generated test.

Based on the responses of the software module collected during the test, the method can output whether the test corresponds to a success or to a failure. In some embodiments, the test can serve e.g. as “regression” test for the software module. Output of the test can be used e.g. by a developer or user of the software module, in order to improve content of the software module.

A non-limitative example of generation of a code for a test is provided below. Assume that the selected sequence of modelled requests, as selected from the data structure, is as follows:
http://ppl.srv.com/api/who?id=VAR1 (with VAR1 an integer, and with possible values of VAR1 extracted from the data structure);
http://ppl.srv.com/api/VAR2/age (with VAR2 equal to the parameter “NAME” obtained as a response of the first request)

A code of a test can include the following operations (the test is expressed in a pseudo-code which is purely illustrative and not limitative):
{r=httpclient.get(“http://ppl.srv.com/api/who?id=% d”, data.id);
assert (r.http_status_code,200);
assert(r.json.isValid( ));
assertNotNull(r.json.name);
name=r.json.name;
r=httpclient.get(“http://ppl.srv.com/api/% s/age”, name);
assert (r.http_status_code,200);
assert(r.json.isValid( ));
return SUCCESS}

Selection of the relevant sequence(s) based on which a test is to be generated can rely on various logics, and in particular, selection of the relevant sequence can be performed so as to meet one or more constraints on the test (as illustrated in operations 730, 740, 750 and 760 of FIG. 7A).

According to some embodiments, assume that the constraint dictates that it is desired to test a given request, while minimizing the total number of requests of the test. This total number is considered as minimal when it meets a criterion (e.g. the criterion can dictate a threshold for the total number, or can indicate that the absolute minimal value has to be found out of all possible sequences that can be generated from the data structure).

For example, in FIG. 6B, it is desired to test modelled request R₇, while minimizing the number of requests of the test. As shown in FIG. 6B, there are two possible sequences for testing modelled request R₇: or sequence 636 (which includes modelled requests (R₁,R₂)->(R3,R6)->R4->R7) or sequence 637 (which includes modelled requests (R₁,R₂)->R₆->R₇), and therefore sequence 637 is selected.

According to some embodiments, assume that the constraint dictates that it is desired to test a limited list of given modelled requests R₁ to R_{N} (which are present in the data structure), while minimizing the total number of requests of the test.

A possible embodiment (which is not limitative) to meet this constraint can include the following flow (starting from i=1):
(1) for modelled request Rᵢ, selecting a sequence of the which ends up by modelled request Rᵢ;
(2) marking all modelled requests of the selected sequence as “covered” by the test;
(3) reverting to (1) for i incremented by one;
(4) stopping the loop when all modelled requests are covered by the test;
(5) if a given modelled request is not covered, generating, in the test, a single modelled request covering this modelled request.

This flow relies on the fact that when a sequence which includes e.g. modelled requests R₁, R₂ and R₃ is selected, not only the last modelled request R₃ of the sequence is tested, but also implicitly all modelled requests present in the sequence (R₁ and R₂). Indeed, in order to end up with modelled request R₃, the software module must first pass the test with respect to modelled requests R₁ and R₂.

Various other constraints can be used to generate the test. For example, in other embodiments, it can be required to test a list of modelled requests in an explicit way, that it to say that each modelled request of the list must be located at the end of a sequence.

Attention is now drawn to FIGS. 8A and 8B.

As explained with reference to the architecture of FIG. 1, a distributed architecture can include a plurality of software modules (e.g. software modules 810₁, . . . 810_{N}), wherein each software module can exchange data with a third party (e.g. another software module, and/or a computing device 820 of a user).

According to some embodiments, it can be required to generate simulation of a behavior of a given software module. This is illustrated in FIG. 8B, in which a given software module 810ₖ is “replaced” by a simulated software module 810′ₖ. As explained hereinafter, the simulated software module 810′ₖ is able to produce responses to given requests, that simulate the true responses that would have been output by the given software module 810ₖ to the given requests (without requiring to execute the given software module 810ₖ itself).

Similarly to the architecture of FIG. 1, a data communication module 840 can be implemented, which is configured to listen to data communication of the given software module to be simulated (in this example 810ₖ). In particular, the data communication module 840 can be similar to the data communication module 140 described above. The data communication module 840 can forward the collected data (training set) in parallel e.g. to a database 850 (or to another third party of interest) and to the original destination of the data (the data communication module 840 acts therefore as a proxy).

A processor and memory circuitry (PMC)(see processing unit 860 and associated memory 870) can be used to process the training set and/or to perform one or more of the methods described hereinafter.

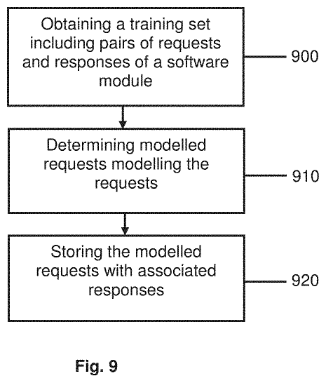

Attention is now drawn to FIG. 9.

Assume that it is intended to generate a simulated software module 810′ₖ of a given software module 810ₖ.

A method can include obtaining (operation 900) a training set including a plurality of pairs of requests and responses of the given software module 810ₖ, wherein for a given pair, the request is received by the software module 810ₖ, and the response is produced by the software module 810ₖ in response to this request.

As explained with reference to operation 200 above, the training set can be collected during operation of the given software module 810ₖ, using e.g. the data communication module 840, which acts as a proxy with respect to the given software module 810ₖ. In some embodiments, the training set can be collected during communication of the given software module with real other software modules and/or with other simulated software modules and/or with one or more computing devices of user(s).

As explained above, in some embodiments, the requests of the training set can include a list of URLs (this is not mandatory).

Operation 900 can include collecting the training set of requests (using data communication module 840) and/or obtaining the training set from a database in which it is already available.

In some embodiments, the training set can be pre-processed using one or more pre-processing tasks described with reference to FIGS. 3 and 4.

The method further includes determining (operation 910) a plurality of modelled requests modelling the requests of the training set.

According to some embodiments, this can include, for each request of a plurality of requests of the training set obtained at operation 900, determining a variable part of the request. Based on this determination, it is possible to generate (operation 910) a modelled request. In particular, the modelled request models request(s) of the training set sharing a same constant part, and a variable part corresponding to a same variable parameter (although the specific value of the variable parameter can differ for these requests).

Various embodiments and examples of determination of the variable part in the requests and generation of the modelled requests have already been described with reference to FIGS. 4, 4A, 5, and 5A to 5D, and can be used in this method.

A data structure can be generated, which stores (see operation 920), for the given software module:
a plurality of modelled requests modelling requests to the software module;
one or more responses associated with each modelled request (in particular, assume that a given modelled request models a plurality of given requests for which the variable part has a different value, then all responses of the training set transmitted by the software module in response to the given requests are associated with the given modelled request).

The modelled requests, and the one or more possible responses associated with these modelled requests, are usable to simulate a response of the software module, upon receipt of a request.

According to some embodiments, it is possible to merge operations performed for generating a test of a software module (as explained with reference to FIGS. 1 to 7), and operations performed for generating a simulation of a software module (as explained with reference to FIG. 9).

Indeed, operation 900 can include listening to data communication of a given software module in order to collect requests and responses. A similar operation is performed in FIG. 2 (see operation 200). As a consequence, collection of requests (and responses) of a software module can be collected once, and used both for generating a test of the software module and a simulation of the software module.

In addition, operation 910 includes determining modelled requests modelling requests of the training set. This operation is also performed in some embodiments to prepare generation of a test of the software module (see operation 530). As a consequence, this operation can be performed once and can be used both for generating a test of the software module and a simulation of the software module.

As explained above, a data structure (first data structure) can be built, which is usable to simulate behaviour of a given software module. As explained with reference to FIGS. 1 to 7, another data structure can be built (a second data structure), which is usable to simulate test of the given software module. In some embodiments, since at least some of the data stored in the first data structure is also stored in the second data structure, a unified data structure can be built, usable both for testing and simulating a given software module (generally testing of a given software module is not performed at the same time as simulating this given software module, since the test aims at testing the “real” software module, and not its simulation). The unified data structure can store.
a plurality of modelled requests modelling requests to the software module;
linking data informative of a link between given modelled requests of the plurality of modelled requests; and
one or more responses associated with each modelled request (in particular, assume that a given modelled request models a plurality of given requests for which the variable part has a different value, then all responses of the training set transmitted by the software module in response to the given requests are associated with the given modelled request).

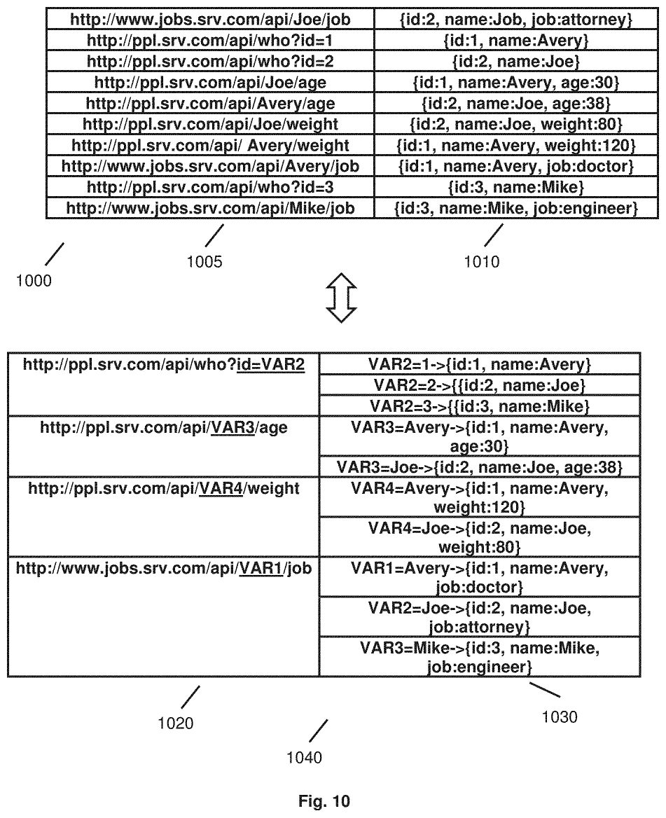

A non-limitative example of the method of FIG. 9 is illustrated in FIG. 10. Assume that a training set 1000, including requests 1005 to the given software module and corresponding responses 1010 of the given software module has been obtained.

The requests 1005 can be modelled by a plurality of modelled requests 1020 in which the variable part has been identified.

For each modelled request, all possible responses are stored, for each possible values of the variable part of the modelled request. This is illustrated in reference 1030. A data structure 1040 is thus obtained.

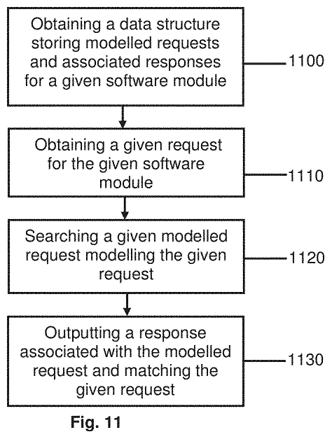

Attention is now drawn to FIG. 11.

Assume that it is desired to simulate behavior of a given software module.

Assume that a data structure (stored e.g. in a memory) is obtained (operation 1100) and stores, for the given software module, a plurality of modelled requests modelling requests to a software module, and one or more responses associated with each modelled request. This data structure can be generated using e.g. the method of FIG. 9.

When a given request is obtained (operation 1110), the simulation of the given software module should output a response which is relevant for this given request.

This can include searching (operation 1120) in the data structure for a given modelled request modelling the given request. This can be performed using e.g. a text recognition algorithm, which outputs the given modelled request that is the most similar to the given request. Once the given modelled request has been identified, it is possible to extract the specific value(s) of the variable parameter(s) in the given request. Indeed, the given modelled request indicates the exact location of the variable parameter(s). A response associated with the given modelled request and which matches the given request is extracted and output (operation 1130). In particular, the response associated with the value of the variable parameter of the given modelled request which corresponds to the value of the variable parameter of the given request, is output.

If the given request is such that there is no corresponding response in the data structure, the method can output data indicative that this request is not supported by the simulated software module.

In a non-limitative example, with reference to FIG. 10, assume that the given request is http://ppl.srv.com/api/Joe/age. It is identified that in the data structure 1040, this given request is modelled by the modelled request “http://ppl.srv.com/api/VAR3/age”. Since the value of VAR3 in the given request is Joe, the simulated software module outputs that the response which is associated with “Joe” for this given modelled request is “{id:2, name:Joe, age:38}”.

Simulation of a given software module can be used in various applications.

According to some embodiments, this can be used to provide a demonstration of the operation of the given software module.

According to some embodiments, this can be used during software development.

According to some embodiments, the simulated software module can be used to test another software module. For example, assume that a given software module has to be tested, and it is known that this given software module communicates with at least one other software module. During test of the given software module, it is generally required to fully import and execute the other software module. If the other software module is simulated as explained above, then it is possible to test the given software model without requiring to implement the whole process of the other software module.

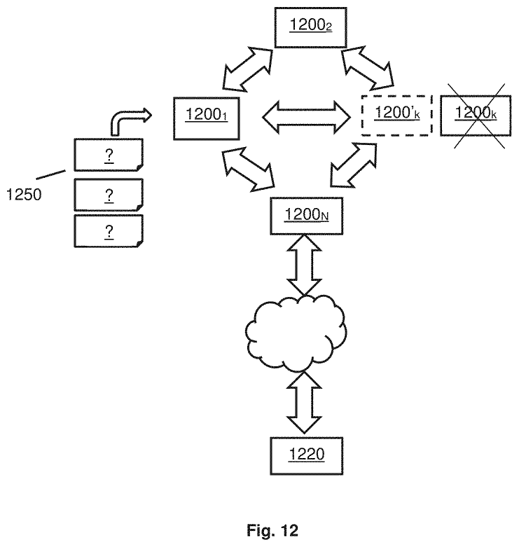

This is illustrated in FIG. 12.

Assume that a software module 1200₁ is to be tested, in a distributed architecture including software modules 1200₁ to 1200_{N} and a computing device 1220 of a user. Generation of a test can rely on the various embodiments described above, and/or on other techniques. During the test, a plurality of requests is sent to the software module 1200₁ (see reference 1250) and based on the response of the software module 1200₁, it is evaluated whether the software module 1200₁ is operative. During the test, the software module 1200₁ may require to send requests to another software module 1200ₖ. Instead of requiring, for the purpose of the test, to implement and import the whole package of the software module 1200ₖ, this software module 1200ₖ can be replaced by a simulated software module 1200′ₖ (using the methods described above), which is much more flexible.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A system comprising a processor and memory circuitry (PMC) configured to:
obtain a training set including requests received by a software module,
determine, based at least on the training set:
a plurality of modelled requests, each modelled request modelling one or more requests of the training set,
linking data informative of a link between given modelled requests of the plurality of modelled requests,
wherein at least one sequence of modelled requests and associated linking data are usable to test the software module, upon execution of requests for the software module in accordance with the sequence and the associated linking data.

2. The system of claim 1, wherein the linking data includes data informative of a link between a value of a variable parameter of at least one modelled request and a response associated with at least one of another modelled request.

3. The system of claim 1, wherein, upon determination of a modelled request, the system is configured to determine, for each request of a plurality of requests of the training set, a variable part of the request.

4. The system of claim 1, configured to:
determine, for each request of a plurality of requests of the training set:
a constant part of the request,
a variable part of the request corresponding to a variable parameter, and
generate a modelled request modelling requests sharing:
a same constant part, and
a variable part corresponding to a same variable parameter.

5. The system of claim 1, configured, for a plurality of given requests of the training set, to:
obtain responses of the software module associated with the given requests,
based on the responses and a variable part determined for each given request, determine data informative of a link between a value of a variable part of a modelled request modelling a given request and a response associated with a modelled request modelling another given request.

6. The system of claim 1, configured to:
determine a plurality of candidates for the linking data, based at least on requests of the training set, responses associated with the request, and a variable part identified for the requests of the training set; and
use a machine learning algorithm to determine the linking data among the plurality of candidates.

7. The system of claim 1, configured to generate, based on at least one sequence of modelled requests and associated linking data, a test usable to test the software module, upon execution of requests in accordance with the sequence and associated linking data.

8. The system of claim 1, configured to:
obtain an ordered sequence of modelled requests, and associated linking data;
generate a request corresponding to a first modelled request of the sequence;
for each of all other modelled requests of the sequence, generate a request which includes a constant part extracted from the modelled request, and a variable part whose value is determined based on the linking data.

9. The system of claim 1, configured to perform at least one of (i) and (ii):
(i) divide the requests of the training set into a plurality of distinct user interactions;
(ii) delete redundant requests.

10. The system of claim 1, configured to test the software module using the test.

11. The system of claim 1, configured to store, for each modelled request, one or more responses of the training set, wherein the modelled requests and the one or more responses are usable to simulate a response of the software module, upon execution of a request for the software module.

12. A system comprising a processor and memory circuitry (PMC) configured to:
obtain, for a software module:
a plurality of modelled requests, each modelled request modelling one or more requests received by the software module, and
linking data informative of a link between given modelled requests of the plurality of modelled requests,
generate, based on at least one sequence of modelled requests and associated linking data, a test usable to test the software module, upon execution of requests for the software module in accordance with the selected sequence and associated linking data.

13. The system of claim 12, wherein, upon testing response of the software module to a given request, the system is configured to generate a test including a number of requests allowing covering the given request which is minimal according to a criterion, based on the plurality of modelled requests and the linking data.

14. The system of claim 12, configured to store, for each modelled request modelling one or more requests, one or more responses of the software module to the one or more requests, wherein the modelled requests and the one or more responses are usable to simulate a response of the software module, upon execution of a request for the software module.

15. A system comprising a processor and memory circuitry (PMC) configured to:
obtain a training set including a plurality of pairs of requests and responses of a software module, and
determine a plurality of modelled requests modelling the requests of the training set, wherein one or more given requests of the training set are modelled by a modelled request including a variable part identified for the one or more given requests,
wherein one or more of the modelled requests and the responses of the training set are usable to simulate a response of the software module, upon receipt of a request.

16. The system of claim 15, configured to, upon simulation of a response of the software module to a given request:
upon receipt of the given request, search for a modelled request modelling the given request, and
output a response associated with the modelled request and matching the given request.

17. A system comprising a processor and memory circuitry (PMC) configured to:
obtain a data structure storing:
a plurality of modelled requests modelling requests to a software module, and
one or more responses of the software module associated with each modelled request;
obtain a given request for the software module, and
generate a response simulating behaviour of the software module in response to the given request, the generating comprising:
search in the data structure for a given modelled request modelling the given request,
output a response which is associated with the given modelled request in the database which matches the given request.
